(19) United States
(12) Patent Application Publication
(10) Pub. No.: US 2018/0075614 A1
(43) Pub. Date: Mar. 15, 2018

(54) Method of Depth Estimation Using a Camera and Inertial Sensor

(71) Applicant: DunAn Precision, Inc., Dallas, TX (US)

(72) Inventor: Hongsheng He, Austin, TX (US)

(21) Appl. No.: 15/723,315

(22) Filed: Oct. 3, 2017

Related U.S. Application Data
(63) Continuation-in-part of application No. 15/701,488, filed on Sep. 12, 2017.
(60) Provisional application No. 62/403,230, filed on Oct. 3, 2016.
(60) Provisional application No. 62/393,338, filed on Sep. 12, 2016.
(60) Provisional application No. 62/403,230, filed on Oct. 3, 2016.

(51) Int. Cl. G06T 7/55; G06T 7/246; H04N 5/232

(52) U.S. Cl. CPC G06T 7/55; G06T 2207/10016; H04N 5/23258; G06T 7/246

(57) ABSTRACT

A method of depth estimation includes the steps of: receiving on a processor a sequence of consecutive images from a camera; receiving on the processor motion data of the camera from an inertial measurement unit associated with the camera; determining with the processor flow features of the captured consecutive images; synchronizing detected flow features of the captured images with motion data of the camera measured by the attached inertial sensor; estimating with the processor a velocity of the camera based on determined feature flow of the images and received motion data of the camera from the inertial sensor; determining with the processor scene depths of the consecutive images based on a scale of the estimated translational velocity of the camera; and iteratively updating estimated scene depths based on additionally captured images from the camera.

### CROSS-REFERENCE TO RELATED APPLICATION

This application claims priority to U.S. Provisional Patent Application Ser. No. 62/403,230 for a Method of Depth Estimation Using a Camera and Inertial Sensor by Hongsheng He, filed on Oct. 3, 2016, and is a continuation-in-part of U.S. patent application Ser. No. 15/701,488 filed on Sep. 12, 2017, which claims priority to U.S. Provisional Patent Application Ser. No. 62/393,338 filed on Sep. 12, 2016, and U.S. Provisional Patent Application Ser. No. 62/403,230 filed on Oct. 3, 2016.

### FIELD

This disclosure relates to a method of depth estimation using a device with visual and inertial sensors.

### BACKGROUND

Industrial cameras and inertial sensors are two types of sensors used in various industrial automation, robotics, unmanned aerial vehicles (UAV), and unmanned ground vehicle (UGV) applications. A common problem in these robotic and industrial applications is to estimate scene depth for different tasks, such as object recognition, localization, assembly, and manipulation. Reliable and effective scene depth estimation relies on dedicated sensors and numerous techniques exist to measure scene depths. The state-of-the-art sensors include active imaging sensor (e.g., Kinect), time of flight sensors (e.g., LiDAR and Ultrasonic) and stereo vision. The major limitation of these sensing technologies is the blind zone when the sensors are used in short-range applications. Active sensors may also not work properly to reconstruct depth for reflective materials such as metallic products and glass. In addition, these sensors are relatively bulky (e.g. Kinect) or expensive (e.g. LIDAR) as compared to a camera.

It is revealed by the camera projection model that the depth information of a scene is lost in a projected image, and therefore different objects may appear similarly in the image plane even though they are at different distance. To this end, many machine vision applications depend on a strict calibration process or a visual gauge to recover the scale of scene depths and object dimensions. Inertial sensors, on the other hand, are able to accurately measure dynamics and short-range movements, which can be used as a “baseline” or a “gauge”. Visual and inertial sensors can be utilized in a collaborative manner by virtue of their complementary properties.

What is needed, therefore, is a method of estimating scene depth utilizing a monocular camera and at least one inertial sensor.

### SUMMARY

The above and other needs are met by a method of depth estimation using a camera and inertial sensor. In a first aspect, a method of depth estimation includes the steps of: receiving on a processor a sequence of consecutive images from a camera; receiving on the processor motion data of the camera from an inertial measurement unit associated with the camera; determining with the processor flow features of the captured consecutive images; synchronizing detected flow features of the captured images with motion data of the camera measured by the attached inertial sensor; estimating with the processor a velocity of the camera based on determined feature flow of the images and received motion data of the camera from the inertial sensor; determining with the processor scene depths of the consecutive images based on a scale of the estimated translational velocity of the camera; and iteratively updating estimated scene depths based on additionally captured images from the camera.

In one embodiment, the sequence of consecutive images is received from one of a monocular camera and a camera array.

In another embodiment, determined flow features of the captured consecutive images include one of features and optical flow of the captured images, wherein intrinsic parameters of the camera are known prior to determining scene depths.

In yet another embodiment, the step of determining flow features further includes: detecting one of features and dense optical flow from a sequence of captured images and obtaining a sequence of feature flow between consecutive images from the sequence of images.

In one embodiment, the inertial sensor is an inertial measurement unit including at least one sensor selected from the group consisting of gyroscopes, accelerometers, and magnetometers, wherein an attitude of the camera, rotational velocities and acceleration of the camera are measured.

In another embodiment, the step of synchronizing feature flow and inertial measurements further includes (1) interpolating the measurements with a high sampling rate by referring the measurements with a low sampling rate and (2) translating the inertial measurements into the coordinate frame with respect to the camera.

In yet another embodiment, the inertial sensor is mechanically associated with the camera. Rotational and translation relation in space between the camera and the inertial sensor is calibrated.

In one embodiment, the step of determining flow features of the captured consecutive images further includes computing parameters of the optical-flow model for each pixel in the captured consecutive images and removing from the optical-flow model the component that is caused by the rotational motion of the camera, which is measured by a mechanically associated inertial sensor.

In another embodiment, a velocity of the camera is estimated by fusing visual feature flow and inertial measurements using a Kalman filter.

In yet another embodiment, the method further includes the steps of back-projecting an estimation of scene depth to the sequence of the images and optimizing the estimated scene depths by minimizing matching errors of a batch of images.

In a second aspect, a method of depth estimation includes the steps of: receiving on a processor a sequence of consecutive images from one of a monocular camera and a camera array; receiving on the processor motion data of the camera from an inertial measurement unit mechanically associated with the camera, the inertial measurement unit including at least one sensor selected from the group consisting of gyroscopes, accelerometers, and magnetometers, wherein an attitude of the camera, rotational velocities and acceleration of the camera are measured; determining with the processor flow features of the captured consecutive images; synchronizing detected flow features of the captured images with motion data of the camera measured by the attached inertial sensor; estimating with the processor a velocity of the camera based on determined feature flow of the images and received motion data of the camera from the inertial sensor; determining with the processor scene depths of the consecutive images based on a scale of the estimated translational velocity of the camera; and iteratively updating estimated scene depths based on additionally captured images from the camera.

### BRIEF DESCRIPTION OF THE DRAWINGS

Further features, aspects, and advantages of the present disclosure will become better understood by reference to the following detailed description, appended claims, and accompanying figures, wherein elements are not to scale so as to more clearly show the details, wherein like reference numbers indicate like elements throughout the several views, and wherein:

FIG. 1 shows a flow chart of a system for estimating scene depth according to one embodiment of the present disclosure;

FIG. 2 shows an illustration of feature flow analysis of a scene according to one embodiment of the present disclosure;

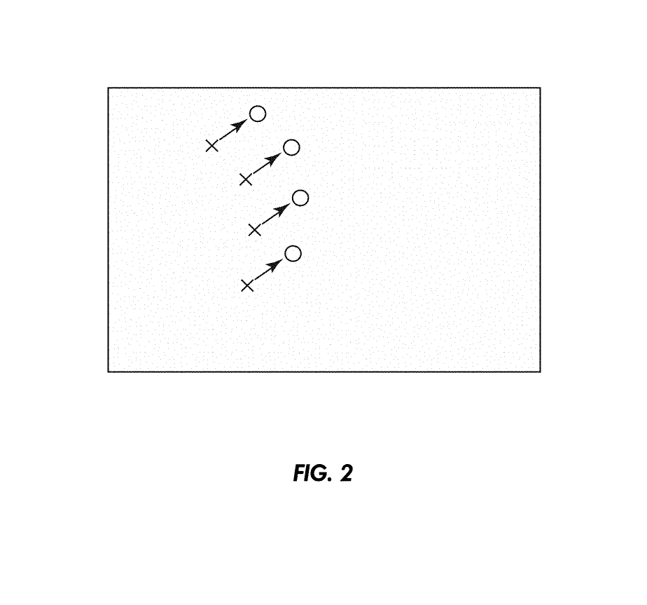

FIG. 3 shows an illustration of feature tracking according to one embodiment of the present disclosure;

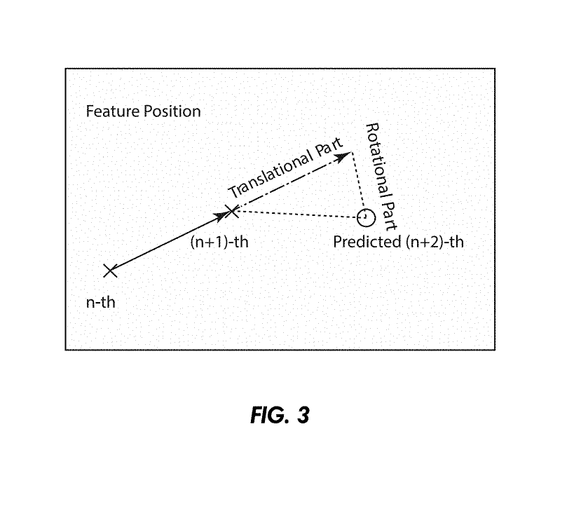

FIG. 4 shows visual depth flow based on feature flow and rotation motion flow according to one embodiment of the present disclosure;

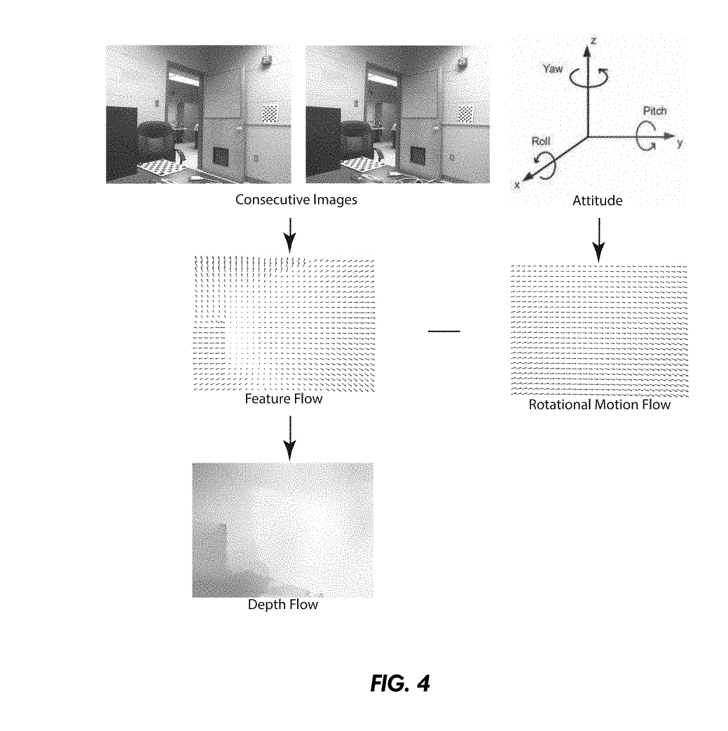

FIG. 5 shows an example of relative depth flow estimation according to one embodiment of the present disclosure;

FIG. 6 shows an example of attempted depth flow estimation using prior art methods and systems;

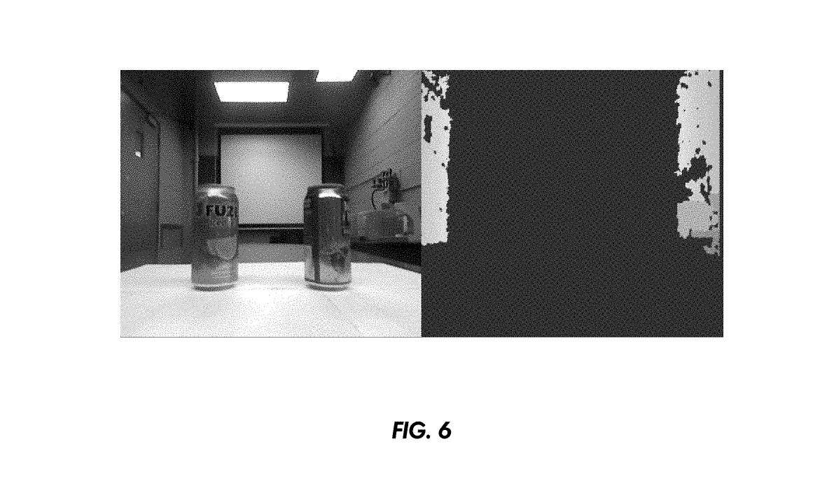

FIG. 7 illustrates iterative optimization of scene depth according to one embodiment of the present disclosure;

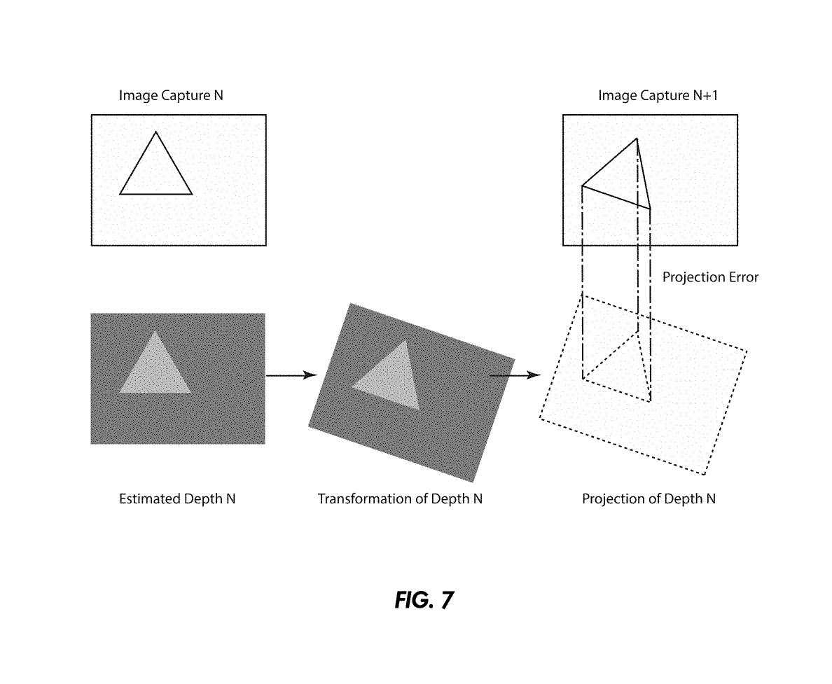

FIG. 8 illustrates a system and method of estimating scene depth according to one embodiment of the present disclosure; and

FIG. 9 shows a flow chart of a system and method of estimating scene depth according to one embodiment of the present disclosure.

### DETAILED DESCRIPTION

Various terms used herein are intended to have particular meanings. Some of these terms are defined below for the purpose of clarity. The definitions given below are meant to cover all forms of the words being defined (e.g., singular, plural, present tense, past tense). If the definition of any term below diverges from the commonly understood and/or dictionary definition of such term, the definitions below control.

A depth estimation method using a monocular camera aided by an inertial sensor is disclosed. The depth estimation method is advantageously able to recover a dense scene depth in short range, as compared to existing sensors such as Kinect sensors and laser sensors. Scene depth is estimated from visual feature flow, that is the motion of tracked feature points in an image frame captured by a camera. Computation of the visual feature flow is expedited by predicting a position of features in consecutive image captures using detected motion of the camera, which is measured by an attached inertial sensor or inertial measurement unit. A component in feature flow caused by the rotational motion of the camera is computed for each feature point with the measured rotational motion of the camera by the inertial sensor, generating a depth flow. Depth flow is a function of scene depths and translational motion, and is iteratively refined by optimizing a smoothing energy function when a new scene image is captured. Real-scale scene depths are obtained from depth flow when translational velocity of the camera is known or estimated by fusing data from the visual and inertial sensor. The disclosed method could be used in industrial automation and robotics applications.

The present disclosure provides an effective method to estimate scene depths using a monocular camera and data related to inertial measurements. Feature flow is computed from correspondences of feature points across consecutive images. The feature correspondences are determined by feature detection and match, which are expedited with an inertial sensor that predicts the position of feature points in a following image. Depth flow is obtained by compensating based on rotational motion in the feature flow, which is measured by the inertial sensor. The computing of depth flow can be conveniently implemented to run in real time when feature tracking and detection are expedited. Real-scale scene depths are obtained from the depth flow given the estimated velocity and the positions of the device. The scene depths are iteratively refined using multiple image frames. The disclosed method is applicable in robotic and industrial automation applications, such as assembly, pin-picking, and production inspection.

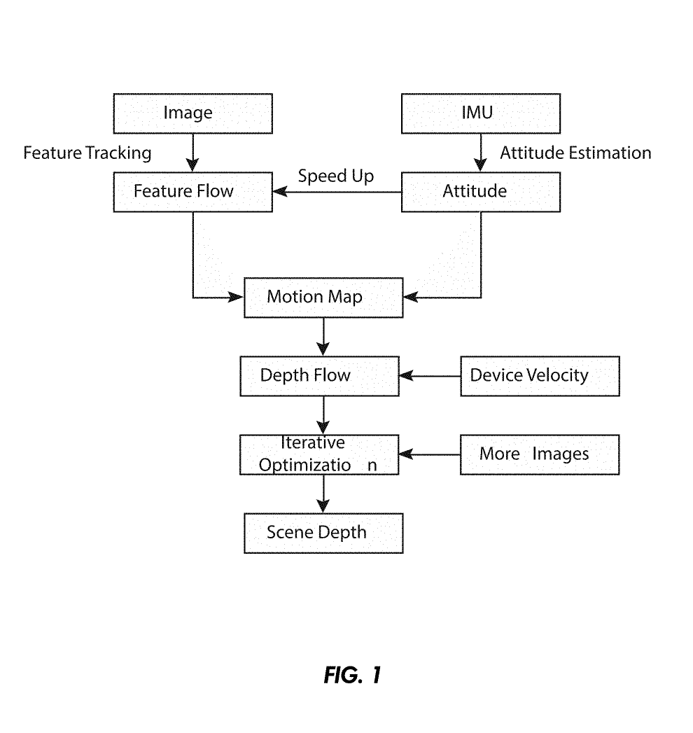

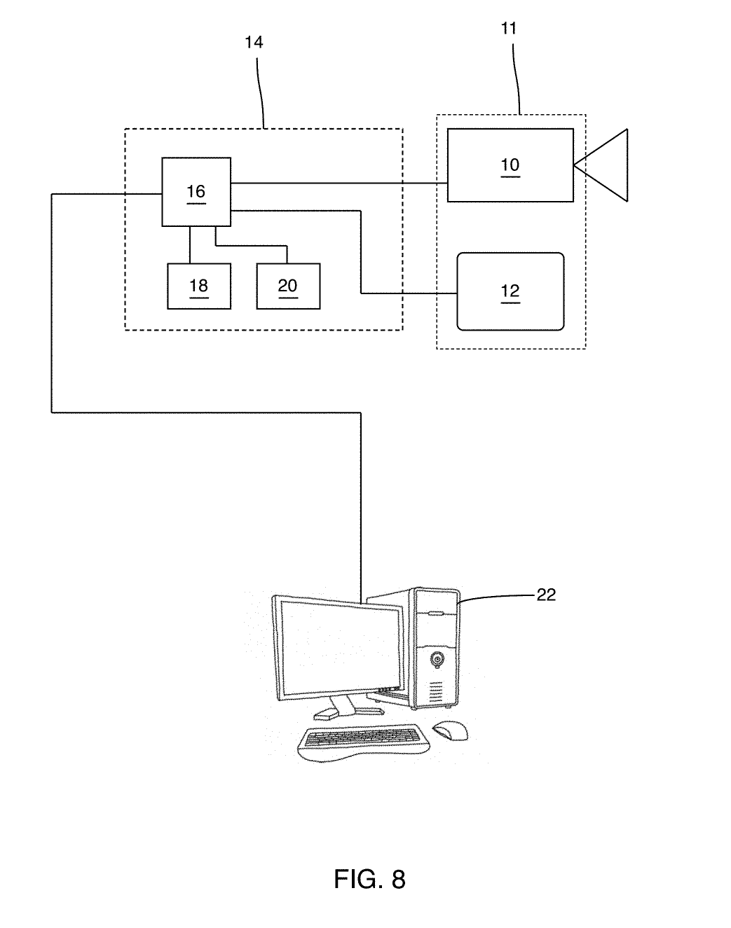

FIG. 1 shows a basic flowchart of the method of depth estimation using a camera and an inertial measurement unit (“IMU”). The method includes capturing an image with a camera, such as a monocular camera, and capture the motion of the camera using an attached IMU. The camera and the IMU are in communication with a controller (FIG. 8). The controller includes a processor and a computer readable storage medium for receiving and processing data from the camera and IMU. The controller includes computer readable code and instructions executable on the processor for processing data from the camera and IMU and determining a scene depth as discussed in greater detail below.

With reference to FIG. 8, both image data and IMU data are collected by a camera 10 and an IMU 12 and transmitted to a controller 14 for processing. The camera 10 and IMU 12 are in electronic communication with a processor 16 of the controller 14. The camera 10 and IMU 12 are associated with one another such that any motion of the camera 10 is detected by the IMU 12. In one example, the camera 10 and IMU 12 are both mounted within an enclosure 11 such that the camera 10 and IMU 12 are mechanically associated and movement of the camera 10 results in a corresponding movement of the IMU 12. The controller 14 further includes one or more computer readable storage mediums, such as a transitory computer readable storage medium 18 (e.g. Random Access Memory or RAM) and a non-transitory computer readable storage medium 20 such as a solid state drive or hard disk drive (HDD). The controller 14 may further be in communication with a host computer 22 that is external to the controller 14 for further processing of data captured by the camera 10 and IMU 12. Feature flow and attitude data are determined from the image sensor and IMU, and a scene depth is determined based on the process described herein. Scene depth data may then be output from the controller 14 to the host computer 22 or other device for appropriate action.

The IMU sensor 12 measures 3-axis linear acceleration, 3-axis angular velocities, and 3-axis magnetometer data. An instantaneous orientation of the camera 10 can be estimated from the accelerometer, magnetometer and gyroscope. Angular motion of the camera 10 is represented in quaternions, which are more efficient than direction cosine matrices, and it is convenient to interpolate between quaternions for smooth camera motion. A derivative of orientation in the sensor frame relative to earth frame is a function of angular velocities. Thus, the orientation of the camera with respect to a global earth frame at a sampling time can be obtained using historic estimations and measurements given a starting point. Instantaneous orientation is computed based on an optimization problem of acceleration and geomagnetism observations at sampling time. The optimization problem can be solved by a Gaussian-Newton algorithm.

Estimated attitude based on data from the IMU is synchronized with data from the camera in time and in space, and projected to a captured camera frame. IMU measurements are expressed in a reference frame, while camera dynamics are expressed relative to the camera's reference. Thus, a spatial configuration between the IMU and the camera should be measured, in addition to their individual calibration, so as to synchronize heterogeneous measurements both in space and time. Rotation is represented in quaternions as quaternion expressions, which are simple and effective to interpolate. Outputs of the visual and inertial sensors are individually optimized and represented in quaternions. This allows an individual sensor to maximally optimize an output of the sensor by well-tuned onboard algorithms and by incorporating other sensors, e.g., the attitude of an IMU is collaboratively computed from gyroscopes, accelerators, and magnetometers. To synchronize the observations in time, the quaternions from the sensor with a higher sampling rate are interpolated with respect to the sampling points of the sensor with a lower sampling rate using SQUAD interpolation.

Estimated attitude is used to assist in the search of corresponding features, which otherwise is very time consuming and error prone. Corresponding feature search plays a role in the disclosed method as it generates a feature flow map for the computation of scene depths. By evaluating the difference between the attitudes estimated by the inertial sensor 12 and the camera 10, moving objects in a dynamic scene may be identified. A visual-sanity-check mechanism aims to improve the efficiency of feature tracking and feature match. The accuracy of feature match determines the accuracy of depth flow estimation, and the search of corresponding feature points between consecutive images consumes the most computation resources in many applications.

Feature flow is movement of corresponding feature points in an image plane in a sequence of images. The movement of the feature points is caused by relative motion between a scene and the camera. A flow map can be computed from the distances of corresponding feature points in consecutive images by feature tracking, e.g., Speeded Up Robust Features (SURF) or by batch matching. The feature flow can also be obtained using dense or sparse optical flow algorithms. Existing methods of determining optical flow, that is movement of points within a visual scene caused by relative motion between a point of view and the scene, are known in the art and may be suitable with embodiments of the present disclosure.

Positions p of corresponding feature points are predicted based on attitude measured by the inertial sensor 12. Movement of feature points pₖ in an image frame has two parts: one part corresponds to translational motion of the camera and the other part results from rotational motion of the camera. The prediction of feature points consists of the movement caused by camera rotation and translation, and vast translation of pixels in the image plane is mainly caused by camera rotation instead of translation. A translational part is coupled with scene depths and the scale of the movement in the image frame is unknown. Instead, the translational motion of the camera is assumed to be constant within a short sampling time, such that the translational part is supposed to be linearly proportional to sampling time span and represented by a linear velocity model. The rotational part is precisely estimated by the relative rotational motion, which is measured by the attached IMU. The movement of feature δp in the unit of pixels in the image frame is predicted by

$$δ {p}_{k + 1} = δ {p}_{k} \frac{Δ {t}_{k + 1}}{Δ {t}_{k}} + {B}_{k} {}_{}^{i}{ω}{}_{k + 1}^{} Δ {t}_{k + 1}$$

where p=(x, y) is the pixel position, Bₖ is the coefficient represented by pixel positions and focal length, and Δtₖ is sampling intervals.

The feature search process can be expedited with a detect-by-track technique, which match features from a landmark database before searching features across the whole image. This technique is especially helpful when there are many overlapping regions between consecutive images while the camera is moving in a small region. In the meantime, the tracked feature points that exist in a sequence of consecutive images are stored as landmarks.

Projection of 3D points is modeled using a pinhole model. Supposing the camera is moving in a static or primarily static environment, a relationship between observed feature flow oᵢ in the image frame and camera motion including translational motion v and rotational motion ω is

$${o}_{i} = \frac{1}{{Z}_{i}} {A}_{i} v + {B}_{i} ω$$

where Aᵢ and Bᵢ are coefficients of pixel positions, and Zᵢ is a scene depth. The observed optical flow consists of two components: Avᵢ/Zᵢ is proportional to translational motion and inversely translational to scene depths; and Bᵢω is proportional to rotational motion. The feature flow can be computed by feature tracking or optical flow.

The rotational motion component Bᵢω of a single feature point is computed from the rotation motion of the camera, which is measured by the IMU. The rotational motion flow of the whole image is obtained by computing the rotational motion component for each pixel point.

The depth flow Zᵢ/vᵢ is computed by subtracting the rotational motion flow from the feature flow. The depth flow is essentially the time of flight for each observation point, which is a critical parameter could be used to evaluate the probability of a potential collision with a moving object in robotic and wearable applications.

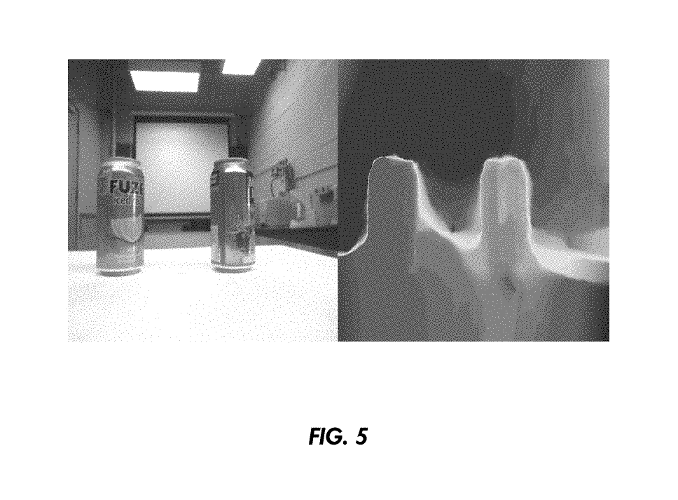

In one example, the depth flow of an indoor scene containing two tins on a table is reconstructed using a visual-inertial sensing unit, as shown in FIG. 5. The sensing system includes a video camera and an attached 10-axis synchronized inertial sensor that measures dynamics of the camera. The model of the camera was a Ximea MQ013CG-ON model camera, which provides color images, auto white balance, and USB 3.0 communication. The model of the inertial sensor was VectorNav VN-100, which has 3-axis accelerometers, 3-axis gyroscopes, 3-axis magnetometers, and a barometric pressure sensor. The high-speed 10-axis inertial sensor outputs real-time and drift-free 3D orientation measurements over complete 360 degrees of motion.

As the result shows, the depth flow clearly presents the relative depth of the scene (red regions are near and blue regions are far). An accuracy of the depth flow depends on the resolution of the camera and the accuracy of feature match. The merit of the disclosed method is that the method is able to recover scene depth at a very short distance. Some active depth sensors, such as Kinect, could not reconstruct scene depth when objects are near the device, i.e., within a blind zone of the sensor.

The scene depths are computed using a sequence of images covering a short baseline and a sufficiently large common view. The scene depths are iteratively refined by minimizing the back-projection error of the common views. The refinement over n-view correspondences will improve the accuracy of depth estimation of overlapped regions and estimation density of the whole scene. The number of frames that can be used in the iterative optimization is constrained by the time and the percentage of the overlaps.

An image capture is selected as the reference frame and the depth flow is computed from the correspondences between the frame and consecutive images. The depth flow is projected to the following frame by multiplying the depth flow with the translation matrix. The projected depth flow is a synthesized depth map expected to be observed at the following frame for the regions of common view.

The projected depth flow is back-projected onto the image frame using the projection model of the camera. The projected image from the reference frame is supposed to be similar to the current image capture except for the regions that are not covered by both points of view. The projection error between the back-projected frame and the captured frame is statistically minimized with respect to the depth flow. In real-time applications, the sampling intervals between image capturing are relative short, and therefore the projection errors are mainly randomly distributed and approximately follow a Gaussian distribution.

The velocities of the camera are observed by fusing the visual feature matching and inertial motion tracking using Kalman filters. Given the velocities of the device, the real-scale scene depth can be obtained from the depth flow by solving a group of linear equations.

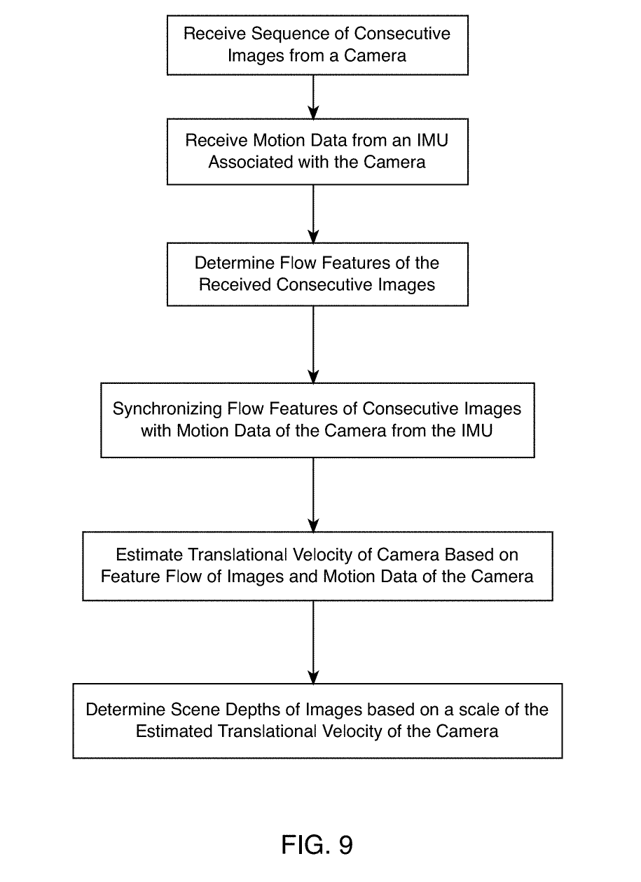

As shown in FIG. 9, a process of determining scene depths of one or more images is provided. A sequence of consecutive images is received from the camera on the processor. Motion data from the inertial measurement unit (IMU) is also received on the processor. Flow features of the consecutive images are determined as described herein, and flow features of the consecutive images and motion data of the camera are synchronized. A translational velocity of the camera is estimated based on determined flow features of the images and motion data of the camera from the IMU. Scene depths of the consecutive images are determined based on a scale of the estimated translational velocity of the camera.

The system and method of depth estimation of the present disclosure advantageously enables a device, such as an industrial robotic arm, unmanned vehicle, or other similar device to determine a depth of objects within a field of view of a visual sensor of the device. Determination of a depth of objects within the field of view may be determined based only on visual data and data related to motion of a camera of the device. By determining depth of objects within a field of view of the device, the system and method of depth estimation of the present disclosure is readily adaptable to existing systems or devices to enable the system or device to determine depth of objects around the device. Scene depth data determined according to the present disclosure may be output from the controller to a host computer or onboard computer of a host device such that the device may act on the determined scene depth. For example, scene depth data may be utilized by the device to determine a distance to an object to be picked up or to avoided. The system and method of depth estimation may be further combined with other sensors of a device to enhance special awareness of the device in an environment.

The foregoing description of preferred embodiments of the present disclosure has been presented for purposes of illustration and description. The described preferred embodiments are not intended to be exhaustive or to limit the scope of the disclosure to the precise form(s) disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the concepts revealed in the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

What is claimed is:

1. A method of depth estimation comprising the steps of:
receiving on a processor a sequence of consecutive images from a camera;
receiving on the processor motion data of the camera from an inertial measurement unit associated with the camera;
determining with the processor flow features of the captured consecutive images;
synchronizing detected flow features of the captured images with motion data of the camera measured by the attached inertial sensor;
estimating with the processor a translational velocity of the camera based on determined feature flow of the images and received motion data of the camera from the inertial sensor;
determining with the processor scene depths of the consecutive images based on a scale of the estimated translational velocity of the camera; and
iteratively updating estimated scene depths based on additionally captured images from the camera.

2. The method of claim 1, wherein the sequence of consecutive images is received from one of a monocular camera and a camera array.

3. The method of claim 2, wherein determined flow features of the captured consecutive images include one of features and optical flow of the captured images, wherein intrinsic parameters of the camera are known prior to determining scene depths.

4. The method of claim 1, the step of determining flow features further comprising:
detecting one of features and dense optical flow from a sequence of captured images and
obtaining a sequence of feature flow between consecutive images from the sequence of images.

5. The method of claim 1 wherein the inertial sensor is an inertial measurement unit including at least one sensor selected from the group consisting of gyroscopes, accelerometers, and magnetometers, wherein an attitude of the camera, rotational velocities and acceleration of the camera are measured.

6. The method of claim 1, wherein the step of synchronizing feature flow and inertial measurements further comprises (1) interpolating the measurements with a high sampling rate by referring the measurements with a low sampling rate and (2) translating the inertial measurements into the coordinate frame with respect to the camera.

7. The method of claim 1, wherein the inertial sensor is mechanically associated with the camera, and wherein rotational and translation relation in space between the camera and the inertial sensor is calibrated.

8. The method of claim 1, wherein the step of determining flow features of the captured consecutive images further comprises computing parameters of the optical-flow model for each pixel in the captured consecutive images and removing from the optical-flow model the component that is caused by the rotational motion of the camera, which is measured by a mechanically associated inertial sensor.

9. The method of claim 1, wherein a velocity of the camera is estimated by fusing visual feature flow and inertial measurements using a Kalman filter.

10. The method of claim 1 further comprising the steps of back-projecting an estimation of scene depth to the sequence of the images and optimizing the estimated scene depths by minimizing matching errors of a batch of images.

11. A method of depth estimation comprising the steps of:
receiving on a processor a sequence of consecutive images from one of a monocular camera and a camera array;
receiving on the processor motion data of the camera from an inertial measurement unit mechanically associated with the camera, the inertial measurement unit including at least one sensor selected from the group consisting of gyroscopes, accelerometers, and magnetometers, wherein an attitude of the camera, rotational velocities and acceleration of the camera are measured;
determining with the processor flow features of the captured consecutive images;
synchronizing detected flow features of the captured images with motion data of the camera measured by the attached inertial sensor;
estimating with the processor a velocity of the camera based on determined feature flow of the images and received motion data of the camera from the inertial sensor;
determining with the processor scene depths of the consecutive images based on a scale of the estimated translational velocity of the camera; and
iteratively updating estimated scene depths based on additionally captured images from the camera.
